(19) United States
(12) Patent Application Publication
(10) Pub. No.: US 2006/0177766 A1
(43) Pub. Date: Aug. 10, 2006

(54) Photoresist for enhanced patterning performance

(75) Inventors: Dong-Ki Lee, Seoul (KR); Hi-Kuk Lee, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/348,855

(22) Filed: Feb. 6, 2006

(30) Foreign Application Priority Data
Feb. 7, 2005 (KR) 10-2005-0011463

(51) Int. Cl. G03C 1/76

(52) U.S. Cl. 430/270.1

(57) ABSTRACT

A photoresist is composed of an alkali soluble resin, a photosensitive agent and a solvent. The alkali soluble resin includes a first type novolak resin synthesized from meta-cresol, and the first novolak resin has an average molecular weight of about 8000 to 25000 and a polydispersity index of four or less. The content of the first type novolak resin in the alkali soluble resin is about 5 to 30 wt. %. The photoresist can further include a second type novolak resin synthesized from a mixture of meta-cresol and para-cresol. The second novolak resin has an average molecular weight of about 2000 to 6000, and the weight ratio of meta-cresol to para-cresol is 4:6. The content of the second type novolak resin in the alkali soluble resin is about 70 to 95 wt. %.

### BACKGROUND OF THE INVENTION

(a) Field of the Invention

The present invention relates to a photoresist.

(b) Description of the Related Art

A liquid crystal display (LCD) device is typically composed of two glass panels, which includes field-generating electrodes such as a pixel electrode and a common electrode, and a liquid crystal (LC) layer interposed between the panels. The LCD device displays images by applying voltages to the field-generating electrodes to generate an electric field in the LC layer, which determines the orientation of LC molecules in the LC layer.

A switching device such as a thin film transistor is generally used in the panel in order to transmit an electrical signal to the pixel electrode. The fabrication of the thin film transistor includes forming, exposing and developing a photoresist layer. In order to improve the patterning resolution of the thin film transistor, it is necessary to improve a develop contrast of the photoresist layer. The term ‘develop contrast’ refers to a ratio of an amount lost in the exposed portion to an amount lost in the unexposed portion.

In order to improve the sensitivity of photoresist layer, a resin that easily dissolves in a developing solution is generally used. When a high solubility resin is used, the solubility of the unexposed portion of the resin also increases. Thus, the residual layer rate decreases as the sensitivity of the photoresist layer increases.

Therefore, a photoresist having excellent sensitivity without deteriorating the residual layer rate and the resolution is required.

### SUMMARY OF THE INVENTION

In accordance with an embodiment of the present invention, a photoresist is composed of an alkali soluble resin, a photosensitive agent and a solvent. The alkali soluble resin includes a first type novolak resin synthesized from meta-cresol, and the first novolak resin has an average molecular weight of about 8000 to 25000 and a polydispersity index of four or less. The content of the first type novolak resin in the alkali soluble resin is about 5 to 30 wt. %.

The photoresist can further include a second type novolak resin synthesized from a mixture of meta-cresol and para-cresol. The second novolak resin has an average molecular weight of about 2000 to 6000, and the weight ratio of meta-cresol to para-cresol is 4:6. The content of the second type novolak resin in the alkali soluble resin is about 70 to 95 wt. %.

The photosensitive agent includes a diazide based compound, for example, 2,3,4,4′-tetrahydroxy benzophenone-1,2-naphthoquinone diazide-5-sulfonate. The content of the alkali soluble resin in the photoresist is about 5 to 45 wt. %, and the content of the photoresistive agent in the photoresist is about 1 to 20 wt. %.

### BRIEF DESCRIPTION OF THE DRAWINGS

FIG. 1 is a graph illustrating the polydispersity index of a novolak resin according to an embodiment of the present invention.

### DETAILED DESCRIPTION OF EMBODIMENTS

The present invention now will be described more fully hereinafter with reference to the accompanying drawings, in which specific embodiments of the invention are shown. The present invention may, however, be embodied in many different forms and should not be construed as limited to the embodiments set forth herein.

A photoresist according to an embodiment of the present invention includes an alkali soluble resin having a first type novolak resin, which is synthesized from a meta-cresol of the following formula 1.

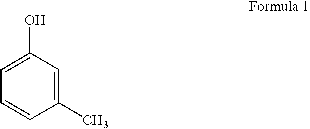

Generally, a novolak resin refers to a polymer produced from a condensation polymerization of a phenol monomer with aldehyde under an acid catalyst.

In this embodiment, the meta-cresol of formula 1 is used as the phenol monomer.

Examples of the aldehyde include formaldehyde, p-formaldehyde, benzaldehyde, nitrobenzaldehyde, acetaldehyde, etc. Each one of these or a mixture of these can be used as the aldehyde for the condensation polymerization. Examples of the acid catalyst include hydrochloric acid, nitric acid, sulfuric acid, formic acid, oxalic acid, etc.

For the synthesizing of the first type novolak resin, 50 wt. % aldehyde, 0.5 wt. % acid catalyst and the balance phenol monomer are used.

The average molecular weight of the first type novolak resin is at least about 8000. In accordance with an embodiment of the present invention, the average molecular weight of the first type novolak resin is about 8000 to 25000. Generally, the use of high molecular weight novolak resin improves the resolution of photoresist patterning. When the molecular weight of the novolak resin increases, the dissolving rate of the photoresist in a developing solution tends to decrease.

Use of the first type novolak resin synthesized from meta-cresol having a proper polydispersity index may improve the sensitivity while maintaining the residual layer ratio and the resolution. Because the meta-cresol dissolves relatively fast in the developing solution, the photoresist having the novolak resin synthesized from meta-cresol enhances the sensitivity of photoresist patterning.

The novolak resin in accordance with an embodiment of the invention has a polydispersity index of about 4 or less. The polydispersity index refers to the weight average molecular weight divided by the number average molecular weight of a polymer.

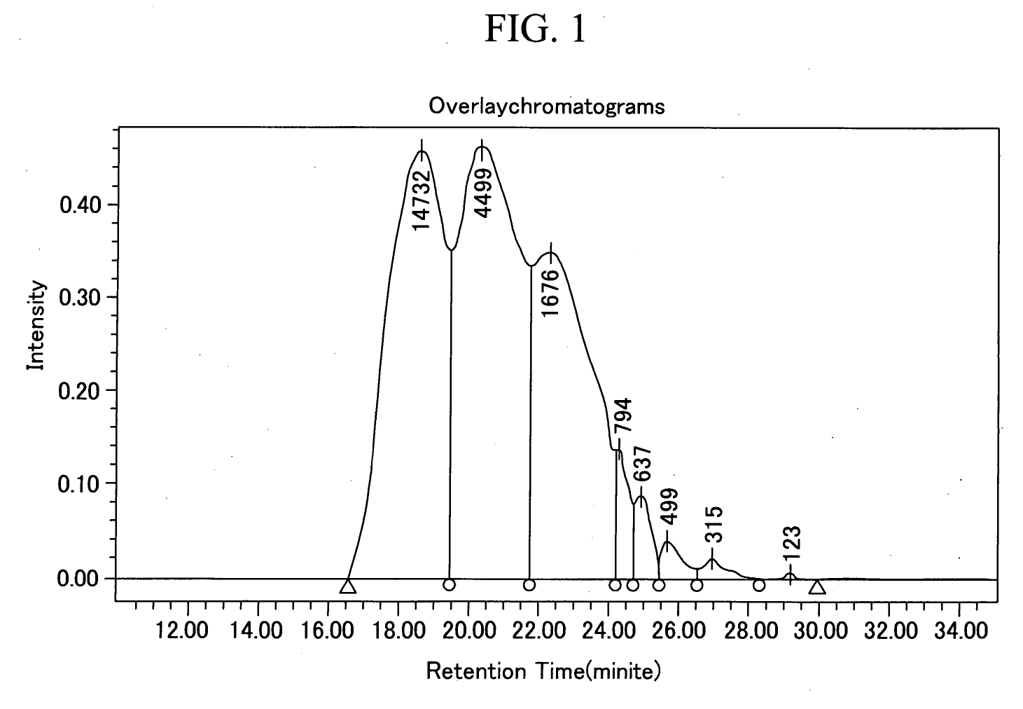

FIG. 1 is a graph illustrating the polydispersity index of the first type novolak resin according to the present invention. The first type novolak resin is synthesized from meta-cresol and has an average molecular weight of about 9400. Referring to FIG. 1, the low molecular weight components have peaks at 123 and 315 atomic units (AU). The medium low molecular weight components have peaks at 637 and 794 AU. The high molecular weight components have peaks at 1676, 4499 and 14732 AU. The solubility of the first type novolak resin can be easily controlled in comparison to the conventional novolak resin because the molecular weight of the novolak resin according to the invention can be easily controlled for each molecular weight group. Therefore, a desired sensitivity can be obtained while the residual layer rate is maintained.

When the photoresist includes less then about 5 wt. % novolak resin, the sensitivity is reduced. When the photoresist includes more than about 30 wt. % novolak resin, the sensitivity increases, and the residual layer rate dramatically decreases. Thus, the photoresist includes about 5 to 30 wt. % first type novolak resin with respect to the total weight of the alkali soluble resin.

The alkali soluble resin further includes a second type novolak resin. The second novolak resin includes a mixture of meta-cresol and para-cresol, in which the weight ratio is 4:6. The second type novolak resin has a weight average molecular weight of about 2000 to 6000. The photoresist in accordance with an embodiment of the invention includes about 70 to 95 wt. % second type novolak resin with respect to the total weight of the alkali soluble resin.

The photoresist includes about 5 to 45 wt. % alkali soluble resin with respect to the total weight of the photoresist. When the photoresist includes less than 5 wt. % alkali soluble resin, the viscosity of the photoresist is reduced such that a pattern having a desired thickness may not be obtained. When the photoresist includes more than 45 wt. % alkali soluble resin, the viscosity of the photoresist increases such that a uniform layer may not be obtained.

The photoresist includes about 1 to 20 wt. % photosensitive agent with respect to the total weight of the photoresist. In one embodiment, a diazide-based compound may be used. Examples of the diazide-based compound include 2,3,4,4′-tetrahydroxy benzophenone-1,2-naphthoquinonediazie-5-sulphonate, 2,3,4-trihydroxy benzophenone-1,2-naphthoquinone diazide-5-sulphonate, etc. These can be used alone or as a mixture. When the amount of the photosensitive agent is less than about 1 wt. %, the sensitivity of the photoresist becomes low. When the amount of the photosensitive agent is more than about 20 wt. %, the sensitivity of the photoresist becomes too high.

The photoresist may further include other additives such as a plasticizer, a stabilizer or a surfactant. The alkali soluble resin, the photosensitive agent and the additives are dissolved in a solvent. Examples of the solvent include ethyl acetate, butyl acetate, diethylene glycol methyl ether, diethylene glycol dimethyl ethyl ether, methyl methoxy propionate, ethyl ethoxy propionate, ethyl lactate, propylene glycol methyl ether acetate, propylene glycol methyl ether, propylene glycol propyl ether, methyl cellosolve acetate, methyl cellosolve acetate, diethylene glycol methyl acetate, diethylene glycol etheyl acetate, acetone, methyl isobutyl ketone, cyclohexanone, dimethyl formamide(DMF), N,N-dimehtyl acetamide(DMAc), N-methyl-2-pyrrolidone, γ-butyro lactone, diethyl ether, ethylene glycol dimethyl ether, diglyme, tetrahydropurane, methanol, ethanol, propanol, isopropanol, methyl cellosolve, ethyle cellosolve, diethylene glycol methyl ether, dietheylene glycol etheyl ether, dipropylene glycol methyl ether, toluene, xylene, hexane, heptane, octane, etc. In accordance with an embodiment of the present invention, the photoresist includes about 50 to 95 wt. % solvent.

In the following examples, sensitivity, residual layer rate and resolution are evaluated using the photoresist according to the present invention.

### EXAMPLES

### Example 1

Preparation of a Photoresist

50 wt. % formaldehyde, 0.5 wt. % oxalic acid and 49.5 wt. % meta-cresol are polymerized by a condensation reaction to prepare the first type novolak resin having a molecular weight of 9375. The second type novolak resin having a molecular weight of 4896 is synthesized from 40 parts by weight of meta-cresol and 60 parts by weight of para-cresol. 10 parts by weight of the first type novolak resin and 90 parts by weight of the second type novolak resin are mixed with 30 parts by weight of 2,3,4,4′-tetrahydroxybenzophenone-1,2-naphthoquinonediazide-5-sulfonate to prepare a mixture having 30% solid content. The mixture is dissolved in propylene glycol monomethyl ether acetate and is filtered through 0.2 μm filter to prepare a photoresist.

Photolithography Process

An aluminum layer and a molybdenum layer are sequentially formed on a glass substrate. The above prepared photoresist is applied on the layers by a spin coating process to form a photoresist layer. The photoresist layer is pre-baked for about 90 seconds at a temperature of about 90° C. Ultra violet rays having the intensity of 12 mW/cm², 45 mW/cm² and 28 mW/cm² at the wavelength of 365 nm, 405 nm, 436 nm, respectively, are irradiated onto the substrate for 5 seconds. The exposed photoresist is developed at 25° C. for 1 minute using 2.38 wt % tetramethyl ammonium hydroxide aqueous solution. The developed photoresist is cleaned for 1 minute using pure water.

### Example 2

Example 2 is the same as Example 1 except that the photoresist including 20 parts by weight of the first novolak resin and 80 parts by weight of the second novolak resin is used. The first novolak resin has a molecular weight of 9375 and is synthesized from meta-cresol. The second novolak resin has a molecular weight of 4896 and is synthesized from 40 parts by weight of meta-cresol and 60 parts by weight of para-cresol.

### Example 3

Example 3 is the same as Example 1 except that the first novolak resin has a molecular weight of 15457.

### Example 4

Example 4 is the same as Example 2 except that the first novolak resin has a molecular weight of 15457.

### Comparative Example

The comparative example 3 is the same as Example 1 except that the photoresist including 100 parts by weight of a novolak resin is used. The novolak resin has a molecular weight of 4896 and is synthesized from 40 parts by weight of meta-cresol and 60 parts by weight of para-cresol.

Experiments

The sensitivities and resolutions of the photoresist obtained in Examples 1, 2, 3 and 4 and Comparative Example were evaluated. The sensitivity was measured using y value after a developing process using a sensitivity mask. The resolution was determined by measuring the minimum size of the pattern using a scanning electron microscope (SEM). The results are shown in table 1.

TABLE 1

| | sensitivity | | | Lost amount after |
|---|---|---|---|---|
| | (mJ/cm²) | Υ¹⁾ | resolution(μm) | development(Å) |
| Example 1 | 27.21 | 0.7 | 1.4 | 854 |
| Example 2 | 32.85 | 0.74 | 1.2 | 758 |
| Example 3 | 29.68 | 0.74 | 1.2 | 525 |
| Example 4 | 36.96 | 0.78 | 1.2 | 650 |
| Comparative | 38.32 | 0.8 | 1.2 | 823 |
| Example | | | | |

¹⁾Υ = 1/(logE2 − logE1), wherein logE1 refers to an exposure amount when the residual layer rate becomes 100% and logE2 refers to an exposure amount when the residual layer rate becomes 0%

As shown in Table 1, the photoresist of Examples 1 to 4 exhibit good sensitivity while the resolution and the residual layer rate are similar to those of Comparative Example. The respective first type novolak resins in Examples 1 to 4 have molecular weights of at least 8000 and polydispersity indexes of at most 4. The dissolving rates of the first novolak resins synthesized from meta-cresol are higher than that of the second type novolak resin having a weight average molecular weight of 2000 to 6000. Hence, the sensitivity of the photoresist of Examples 1 to 4 is superior to that of Comparative Example.

In Examples 1 and 3, the content of the first type novolak resin in the photoresist is the same. The photoresist of Example 1 has a superior sensitivity to that of Example 3. The photoresist of Example 3 has a superior resolution to that of Example 1. As the molecular weight of the first type novolak resin increases, the dissolving rate of the photoresist in the alkaline aqueous solution reduces. Thus, y value increases, and the resolution is enhanced.

The first type novolak resins used in Example 1 and Example 2 have the same molecular weight as and different content in the photoresist from each other. The photoresist of Example 1 has better sensitivity than that of Example 2, because the content of the first type novolak resin having higher dissolving rate in the developing solution is lower. The photoresist of Example 2 has better resolution than that of Example 1, because the content of the first type novolak resin having lower dissolving rate is higher. In the same way, the first type novolak resins used in Example 3 and Example 4 have the same molecular weight as and different content in the photoresist from each other. The photoresist of Examples 3 has better sensitivity than that of Example 4, because the content of the first type novolak resin having higher dissolving rate in the developing solution is lower. The photoresist of Example 4 has better resolution than that of Example 3, because the content of the first type novolak resin having lower dissolving rate is higher.

When the content of the first type novolak resin synthesized from meta-cresol increases, the molecular weight of the photoresist increases. Thus, the dissolving rate of the photoresist in the alkaline developing solution reduces, and the resolution increases.

The molecular weight of the first type novolak resin is higher than that of the second type novolak resin. The sensitivity of the photoresist having the first type novolak resin is superior to the sensitivity of the photoresist having the second type novolak resin. This is because the total content of meta-cresol, which has a high dissolving rate, is higher in the first type novolak resin than in the second type novolak resin. Moreover, because the molecular weight of the first type novolak resin is large, the total molecular weight of the resin increases, and the sensitivity is enhanced while the resolution and the residual layer rate are maintained. Further, materials having low molecular weight, medium molecular weight and high molecular weight were formed in each position and the amount of unreacted materials was reduced. Thus, the amount dissolved in the developing solution was reduced and the sensitivity was improved.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A photoresist comprising an alkali soluble resin, a photosensitive agent and a solvent, wherein the alkali soluble resin comprises a first type novolak resin synthesized from meta-cresol, the first novolak resin having an average molecular weight of about 8000 to 25000.

2. The photoresist of claim 1, wherein the first novolak resin has a polydispersity index of less than or equal to 4.

3. The photoresist of claim 1, wherein the content of the first type novolak resin in the alkali soluble resin is about 5 to 30 wt. %.

4. The photoresist of claim 1, further comprising a second type novolak resin synthesized from meta-cresol and para-cresol, the second novolak resin having an average molecular weight of about 2000 to 6000, wherein the weight ratio of meta-cresol to para-cresol is 4:6.

5. The photoresist of claim 4, wherein the content of the second type novolak resin in the alkali soluble resin is about 70 to 95 wt. %.

6. The photoresist of claim 1, wherein the photosensitive agent comprises a diazide based compound.

7. The photoresist of claim 6, wherein the photosensitive agent comprises 2,3,4,4′-tetrahydroxy benzophenone-1,2-naphthoquinone diazide-5-sulfonate.

8. The photoresist of claim 1, wherein the content of the alkali soluble resin in the photoresist is about 5 to 45 wt. %.

9. The photoresist of claim 1, wherein the content of the photoresistive agent in the photoresist is about 1 to 20 wt. %.
